(19) United States
(12) Patent Application Publication
(10) Pub. No.: US 2026/0128685 A1
(43) Pub. Date: May 7, 2026

(54) High-Voltage DC Transmission System

(71) Applicant: Wisconsin Alumni Research Foundation, Madison, WI (US)

(72) Inventors: Daniel Ludois, Middleton, WI (US); David Skrovanek, Madison, WI (US); Dominic Gross, Madison, WI (US)

(21) Appl. No.: 18/938,723

(22) Filed: Nov. 6, 2024

(51) Int. Cl. H02N 1/06; H02J 3/36

(52) U.S. Cl. CPC H02N 1/06; H02J 3/36

(57) ABSTRACT

An electrostatic generator adapted for high-voltage DC transmission provides a set of individual electrostatic generators connected in tandem to a mechanical input and employing floating voltage sources to allow series connection of the individual electrostatic generators without diode ladders or the like. Brushless operation can be provided through generator building blocks having electrically separated stators communicating with electrically joined rotors.

### STATEMENT REGARDING FEDERALLY SPONSORED RESEARCH OR DEVELOPMENT

### CROSS REFERENCE TO RELATED APPLICATION

### BACKGROUND OF THE INVENTION

The present invention relates generally to high-voltage electrical transmission using direct current and in particular to a high-voltage electrical transmission system using electrostatic generators.

Electrical power must frequently be transmitted a substantial distance from a generation source to its point of use using high-voltage transmission lines. Long-distance transportation can be particularly important for many clean energy sources such as hydroelectric, solar, and wind where the generating sources cannot be readily located close to the ultimate consumer.

Commonly, methods of high-voltage electrical transmission make use of alternating current electricity at kilovoltage levels. Alternating current permits the use of transformers to step the voltage up for efficient long-distance transmission (reducing resistive losses) and then to step the voltage down again for use by the consumer.

There are a number of drawbacks to the transmission of high voltage alternating current including: induced or eddy current losses in surrounding material (for example, seawater surrounding undersea lines), reactive power losses, that is, resistive losses in reactive phases of current flow which do not contribute to power transmission, and skin effects which cause current to be concentrated unevenly through the conductors reducing conductor efficiency. The use of alternating current also introduces the complexity of synchronizing multiple generators to a common phase when their outputs are confined.

The above drawbacks can be largely eliminated through the use of high-voltage DC transmission (HVDC). A conventional approach to HVDC uses common magnetic synchronous generators to produce alternating current power stepped up to high voltages in excess of 100 kV using electrical transformers. This high-voltage alternating current is then converted to DC power for transmission using, for example, a voltage source converter or other rectifying system. At the receiving end of the transmission line, the high-voltage direct current is converted to AC power using a solid-state commutator.

Electrostatic generators present an attractive alternative to magnetic synchronous generators for high-voltage DC transmission because they can inherently operate at higher voltages eliminating the need for a step-up transformer and commutative rectifier such as centralized voltage source converters operating at the transmission voltage level. Such electrostatic generators may employ a high-voltage excitation source operating to charge a variable capacitor produced by movable plates on a stator and rotor and operating as a charge pump to output current proportional to the excitation voltage.

A current challenge in the use of electrostatic generators is a practical limit to the excitation voltage, dictated in part by breakdown voltages across the capacitive gaps between the generator plates, resulting in an output that is less than the desired transmission voltages for high transmission. One method of addressing this limitation is to combine the output of multiple electrostatic generators together using a diode ladder such as is described, for example, in S. F. Philip, “The vacuum-insulated, varying capacitive machine,” IEEE Transactions on Electrical Insulation, volume 12, number 2, pages 130-136, 1977, hereby incorporated by reference.

### SUMMARY OF THE INVENTION

The present invention provides an improved system for combining the outputs of electrostatic generators to produce a desired, greater high voltage through the use of floating excitation sources. In some embodiments, brushless combinations of these different sources can be obtained by electrically interlinking two different sets of rotor plates to present excitation terminals exclusively at locations on the two stators associated with the two different sets of rotor plates. Elimination of a diode ladder required to connect a single excitation source to multiple generators reduces delays in the control of the output voltage caused by the need to charge a diode ladder over successive cycles, and thus produces a system practical for integration into high-voltage DC transmission networks that must promptly respond to the variable demand.

In one embodiment, the invention provides a high-voltage electrostatic generator system having an input shaft adapted to move under an applied mechanical force and a set of electrostatic generators communicating with the input shaft. Each electrostatic generator includes a set of rotor plates communicating with the input shaft to move with motion of the input shaft and a set of corresponding and stationary stator plates capacitively coupled to the rotor plates to provide at least one varying capacitor between corresponding stator plates and rotor plates with movement of the rotor plates. In each electrostatic generator, a floating voltage source is connected to provide a source of electrical charge to the varying capacitor. A rectifier assembly operates to steer current from a change in the varying capacitor along a single charging direction. The high-voltage electrostatic generator system connects the rectifier assemblies of the set of electrostatic generators in series.

It is thus a feature of at least one embodiment of the invention to overcome the voltage limitations of individual electrostatic generators by using isolated voltage sources to connect the electrostatic generators in series without the drawbacks of ladder circuitry.

A subset of first and second sets of rotor plates may electrically communicate through a conduction path moving with the input shaft and wherein the floating voltage sources for each electrostatic generator may be connected across stator plates associated with different of the first and second sets of rotor plates.

It is thus a feature of at least one embodiment of the invention to eliminate the need for brushes or the like for connecting the different generators each to a different floating voltage source.

The rotor plates of different pairs of the subset of first and second sets of rotor plates may be at different voltages.

It is thus a feature of at least one embodiment of the invention to divide an HVDC voltage across rotors and stators on a common mechanical shaft to overcome motor voltage breakdown limits.

The floating voltage sources may have a voltage in excess of 1000 V.

It is thus a feature of at least one embodiment of the invention to allow high voltage suitable for HVDC to be developed with practical numbers of electrostatic generators.

Each rotor plate and stator plate may provide multiple variable capacitors having different phases of capacitance with respect to motion of the input shaft, and the rectifier assembly may provide a separate rectifier circuit for each of the multiple variable capacitors operating to steer current from a change in the multiple variable capacitors along a common charging direction.

It is thus a feature of at least one embodiment of the invention to implement multiphase electrical generation to reduce ripple high-voltage DC current in an electrostatic generator design.

The rectifier assembly may steer current in either of two directions from the varying capacitor to the single charging direction.

It is thus a feature to provide full-wave rectification for reduced current ripple. The high-voltage electrostatic generator system may further include a bus capacitor connected in parallel across one or more of the rectifier assemblies receiving current from the variable capacitor in the single charging direction to charge the capacitor.

It is thus a feature of at least one embodiment of the invention to provide local energy storage for reducing current ripple.

The rectifier assembly may include a DC-DC converter for the purpose of voltage adjustment, power factor correction, or active rectification.

The high-voltage electrostatic generator system may further include an output voltage monitor monitoring a voltage across the series connected electrostatic generators and controlling the voltages of the floating voltage sources according to that monitoring.

It is thus a feature of at least one embodiment of the invention to provide an electrostatic generator that can be teamed with other DC generators in a network to be responsive to variations in load without separate communication channels but by monitoring electrical droop.

The output voltage monitor may increase the excitation voltage as the monitored voltage rises above a predetermined offset value.

These particular objects and advantages may apply to only some embodiments falling within the claims and thus do not define the scope of the invention.

### BRIEF DESCRIPTION OF THE DRAWINGS

FIG. 1 is an overview of the components of an HVDC transmission system incorporating the present invention;

FIG. 2 is a simplified exploded view of a stator and rotor being parts of an electrostatic generator and showing plates which provide a capacitor which varies in value with rotation of the rotor with respect to the stator;

FIG. 3 is a schematic diagram of an electrostatic generator circuit incorporating the variable capacitor of FIG. 2 and providing a rectifier assembly for charging a bus capacitor;

FIG. 4 is a side elevational view of an arrangement of rotors and stators with rotor plates that are electrically connected by a shaft conductor to permit both terminals of the variable capacitor to be located on stator plates for brushless power conduction;

FIG. 5 is a schematic diagram showing the variable capacitors produced by the configuration of FIG. 4 such as combine effectively into a single variable capacitor when the plates of the rotor and stator are in phase;

FIG. 6 is a system diagram showing incorporation of multiple electrostatic generators of FIG. 4 into a combination to provide a high-voltage electrostatic generator system for producing a high-voltage output for HVDC transmission;

FIG. 7 is a figure similar to FIG. 2 showing an arrangement of plates for implementation of a multiphase electrostatic generator;

FIG. 8 is a representation of the variable capacitors produced by the configuration of FIG. 7 and their relative phasing;

FIG. 9 is a figure similar to FIG. 3 showing modification of the rectifier system for a multiphase system;

FIG. 10 is a graph showing changes in power output with changes in excitation voltage or pitch;

FIG. 11 is a block diagram of a control system for implementing droop control of the hi-voltage electrostatic generator system for integration into a transmission network;

FIG. 12 is a figure similar to FIGS. 2 and 7 showing a synchronous electrostatic machine having an energized rotor obtaining power through an inductive coupling to the rotor;

FIG. 13 is a figure of an alternative capacitive coupler for providing power to the rotor;

FIG. 14 is a figure similar to FIGS. 5 and 9 showing the rectifier system that may be connected in series with rectifier systems of other such generators; and

FIG. 15 is a fragmentary block diagram of a rectifier assembly including a DC to DC converter such as a boost or buck converter or power factor correction or active rectifiers; and

FIG. 16 is a excitation voltage control curve implemented by the control system of FIG. 11.

### DETAILED DESCRIPTION OF THE PREFERRED EMBODIMENT

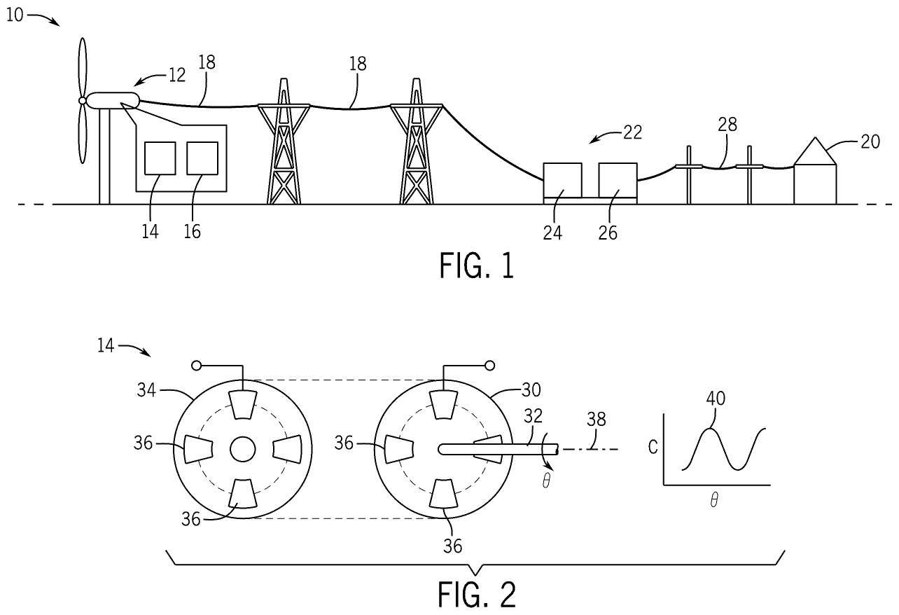

Referring now to FIG. 1, a high-voltage DC (HVDC) transmission architecture 10 may provide one or more generation sources 12, for example, a wind turbine, providing a mechanical source of power. More generally, the high-voltage electrostatic generator system 14 may be associated with any mechanical generations source, for example, conventional steam turbines using chemical combustion or nuclear reaction, hydroelectric power plants, and the like. In each case, the generation source 12 will communicate the mechanical power source to a high-voltage electrostatic generator system 14 and control electronics 16 operating together to produce high-voltage DC on a transmission conductor 18.

The high-voltage electrostatic generator system 14 and control electronics 16 will typically provide voltages on the transmission conductor 18 at voltages in excess of 50 kilovolts and typically in the range between 100 kV and 800 kV, and may extend over a long distances for example, hundreds of miles overland, or a few miles as submerged cables for offshore wind farms and the like.

Prior to electrical power on the transmission conductor 18 being received by a consumer 20, the transmission conductor 18 may connect with a substation 22 providing a solid-state inverter 24, for example, converting the high-voltage DC to 60 Hz AC and a step down transformer 26 reducing the voltage to sub-kilovolt levels (e.g., 120 V) which may be transmitted on low tension cables 28 to homes and businesses of the consumer 20.

Referring now to FIG. 2, the high-voltage electrostatic generator system 14 may include multiple rotors 30 connected, for example, to a mechanical driveshaft 32 receiving the mechanical energy. The mechanical driveshaft 52 rotates the rotors 30 with respect to adjacent stators 34 which may be fixed relative to the rotation of the driveshaft 32 and thus without connection to the driveshaft 32. In one embodiment the rotor 30 and stator 34 may be in the form of multiple parallel adjacent insulating disks arranged along and perpendicular to a rotational axis 32. Opposed surfaces of the rotor 30 and stator 34 support multiple electrically conductive plates 36 spaced angularly about a rotational axis 38 of the driveshaft 32. As positioned, the plates 36 of the rotor 30 and stator 34 are positioned to successively align and move out of alignment with each other so as to create, between the plates of the rotor 30 and the plates 36 of the stator 34, a capacitor 42 whose capacitance varies regularly, for example, in a triangle or sine-like function with the angle of the driveshaft 32. In this embodiment, the plates 36 of the rotor 30 or stator 34 are joined electrically (as indicated by a dotted line) and may be spaced at regular angles to occupy approximately half the circumferential area. Other configurations producing a variable capacitor 42 are also contemplated. Generally, the plates 36 may be placed on both sides the rotor 30 and/or stator 34 with multiple interleaved rotors 30 and stators 34 on or about a driveshaft 32 increasing the peak value of the variable capacitor 42.

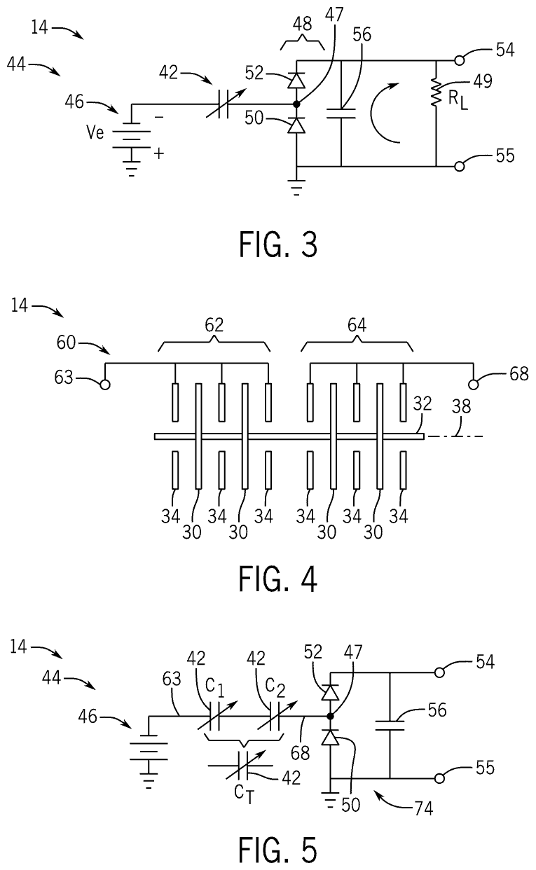

Referring now to FIG. 3, the variable capacitor 42 produced by the plates 36 as they move with respect to each other on the rotor 30 and stator 34 may be incorporated into a generator circuit 44 in which a DC excitation voltage source 47 (Vₑ) provides an initial charge to the variable capacitor 42, for example, in excess of 1000 V. Changes in the variable capacitor 42 then cause the variable capacitor 42 to pump charge toward or away from a junction 47 into a rectifier assembly 48. The rectifier assembly 48 steers current in a clockwise direction (as shown) through a load resistance 49 (representing a power consumer 20) regardless of the direction of current flow into the junction 47 from the variable capacitor 42. In this regard the rectifier assembly 48 provides a full wave rectifier having a first diode 50 having its cathode connected to the junction 47 and its anode connected to ground 55 and a second diode 52 having its anode connected to the junction 47 and its cathode connected to a high-voltage output terminal 54. The resistive load 49 is connected across the high-voltage output terminal 54 and ground 55.

A bus capacitor 56 may shunt the series connected diodes 50 and 52 to smooth current flow in between cycles of the variation in the capacitor value of the variable capacitor 42. Note that negligible power is consumed from the excitation voltage source 46 beyond that required for the initial charging and incidental leakage of the capacitor 42. Rather the power is extracted from the variable capacitor 52 and the mechanical forces necessary to move its plates against countervailing electrostatic forces.

Referring now to FIG. 4, an electrostatic generator 60, such as forms a building block of the high-voltage electrostatic generator system 14, may be constructed of a series of interleaved rotors 30 and stators 34. The rotors 30 are connected on a common driveshaft 32 which also provide a conductive path joining each of the plates 36 of each of the rotors 30 either through a conductive metal of the common driveshaft 32 or by a conductor attached to rotate with the driveshaft 32. The number of interleaved rotors 30 and stators 34 may be increased arbitrarily beyond that shown in simplified form in FIG. 4.

In this construction, the rotors 30 and stators 34 are divided into a first and second subset 62 and 64 with the stators 34 of the first subset 62 connected to a first terminal 63 and the stators 34 of the second subset 64 connected to a second terminal 68. This connection forms two variable capacitors: C₁ formed between the rotors 30 and stators 34 of the first subset 62 and C₂ formed between the rotors 30 and stators 34 of the second subset 64. These two capacitors C₁ and C₂ are connected in series by virtue of the intercommunication of the rotors 30 of the first subset 62 and second subset 64 through the driveshaft 32. When the phases of the capacitors C1 and C2 are adjusted to be identical via proper alignment of their plates, this series combination provides an equivalent single variable capacitor C_{T} summing the capacitor values of these individual capacitors C₁ and C₂. Capacitor C_{T} operates in an equivalent manner to the variable capacitor 42 shown in FIG. 3 with the important feature of having terminals that are stationary and thus do not require rotating couplings for electrical communication.

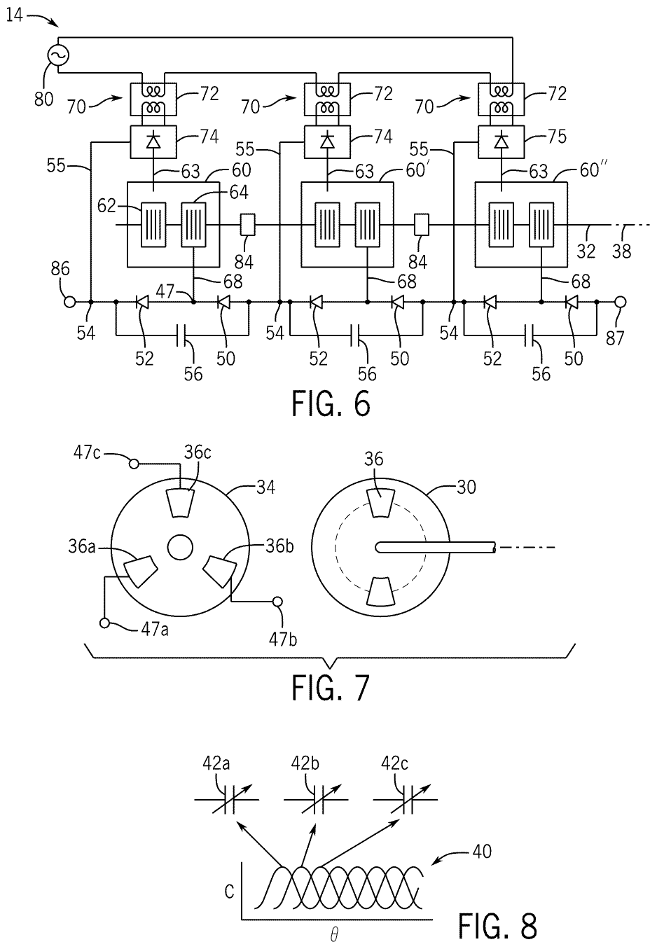

Referring now to FIG. 6, the individual electrostatic generators 60 may be combined into the high-voltage electrostatic generator system 14 by connecting them in series, boosting the voltage of the high-voltage electrostatic generator system 14 beyond the individual voltages of the electrostatic generator 60 and their excitation voltage sources 46 to reach value suitable for HVDC transmission. It will be appreciated that the individual electrostatic generators 60 are modular and interchangeable and may be combined in parallel to boost the current period or combined in chains a serial and parallel connections. In implementing this combination, terminal 63 of the variable capacitor 42 of each electrostatic generator 60 may receive an excitation voltage from a floating voltage source 70. In one embodiment the floating voltage source 70 may be implemented with an isolating transformer 72 whose secondary winding is connected to a rectifier system 74, for example, providing a full wave rectifier. The primary winding of the isolating transformer 72 connects to a source of AC voltage 80 typically having a root mean square voltage value equal to the desired value of the excitation voltage source 46, for example, greater than 480 V as possibly modified by the turns ratio of a transformer. This AC voltage 80 may be shared among each of the floating voltage sources 70.

An important feature of a floating voltage source 70 is that its output, before connection to an electrostatic generator 60, has no fixed value with respect to a ground reference of the AC voltage 80. This quality of floating can also be characterized by the lack of any ohmic connections (that is connections that provide for indefinite DC current flow) with any other of the floating voltage sources 70 associated with other generators 60 prior to connection to the electrostatic generator 60. In this regard, a local ground 55 of each output of a floating voltage source 70 can and will be at a different voltage with respect to the local ground 55 of other floating voltage sources 70.

A common driveshaft 32 will typically join each of the electrostatic generators 60; however, electrical communication between the rotors 30 within each electrostatic generator 60 does not extend between electrostatic generators 60, for example, as enforced by an insulating coupling 84 that may break electrical conduction through the driveshaft 32 when the driveshaft 32 is used for electrically joining the plates 36 of the rotors 30 within each of the electrostatic generators 60.

As well as being positioned on a common driveshaft 32, the electrical outputs of the multiple electrostatic generators 60 may be joined by placing their rectifier assemblies 48 in series between terminals 86 and 87 of the high-voltage electrostatic generator system 14. More specifically, the local ground 55 of a first electrical generator 60 may be connected to terminal 86 with its high-voltage output terminal 54 connected to the local ground 55 of the next succeeding electrical generator 60′. In turn, the high-voltage output terminal 54 of the next succeeding electrical generator 60′ may be connected to the local ground 55 of the next electrical generator 60′ and so forth, with terminal 87 connected to the output terminal 55 of the final series connected electrical generator 60. Bus capacitors 56 may be placed across each rectifier assembly 48 as previously described or across the entire combination. Each of these electrostatic generators 60 will desirably have their plates arranged to provide identical phasing of corresponding variable capacitors 42 with respect to the angle of the driveshaft 32.

Referring now to FIGS. 7 and 8, in an alternative embodiment, the single effective electrical plate 36 on each of the rotor 30 and stator 34 shown in FIG. 2 can be modified, for example, by providing individual connections to different plates 36a, 36b, and 36c arranged to different variable capacitors 42a, 42b, and 43c between the plates 36 of the rotor 30 and the plates of the state or 34. The arrangement of the plates 36 will be such that each of the variable capacitors 42a, 42b, and 43c has a different phase, for example, separated by 120° for a three-phase system.

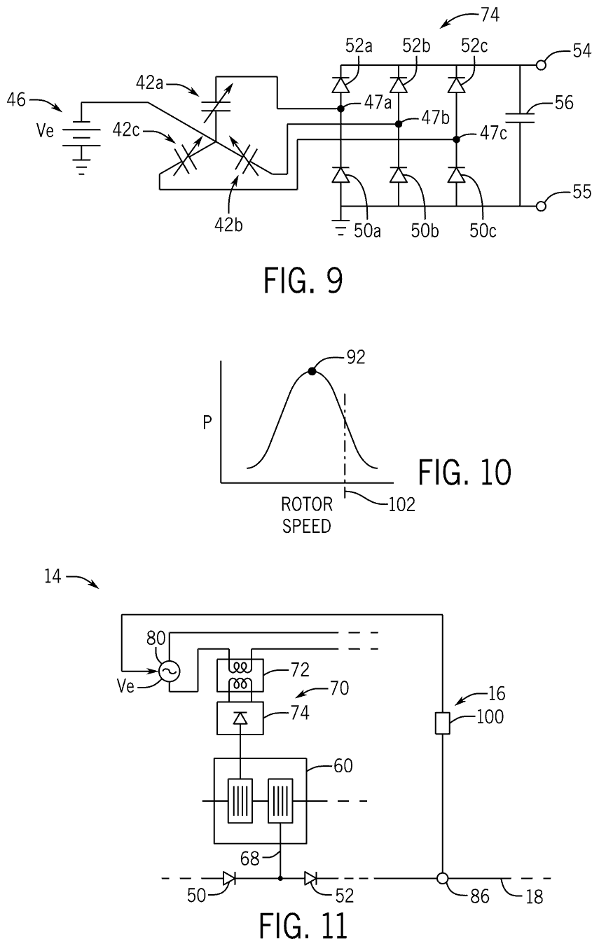

Referring now to FIG. 9, first terminals of these variable capacitors 42a, 42b, and 43c may be connected together at a junction 90 in a so-called “Y” configuration, junction 90 attached to the excitation voltage source 46. The remaining terminals of the variable capacitors 42a, 42b, and 43c connect at junctions 47a, 47b, 47c between respective pairs of diodes 50 and 52. The pairs of diodes 50 and 52 associated with each of the junctions 47a, 47b, 47c are then connected in parallel across the terminals 54 and 55, and the resulting electrostatic generator 60 assembled into a high-voltage electrostatic generator system 14 by connecting the terminals 54 and 55 as shown in FIG. 6. The multiple phases produced by the phase shifted variable capacitors 42a, 42b, and 43c provide for less ripple in the generated direct current. This approach can be readily expanded to phases beyond the three phases herein described. High-voltage electrostatic generator system 14 will be a function of a number of variables including the load, generator speed (for example, controlled by blade pitch angle in the case of a wind turbine) and excitation voltage Vₑ. In order to integrate multiple high-voltage electrostatic generator systems 14 into an electrical grid with other such high-voltage electrostatic generator systems 14, a DC voltage droop control may be implemented in which one or both of the excitation voltage Vₑ and, implicitly, the generator speed are controlled according to a sensed output voltage on the transmission line 18. Further control inputs may be adjusted based on the generator speed or DC voltage (for example, the blade pitch angle in the case of a wind turbine or gate of a steam turbine).

Referring also to FIGS. 10, 11, and 16, in one embodiment, the control circuitry 16 may include a monitoring circuit 100 monitoring the voltage at the output terminal 87 to detect a decrease (increase) in DC voltage (V_{DC} in FIG. 16) within an operating region of voltage ranges 106 caused by increased (reduced) electrical demand. This monitoring may be used to control the operating point 102 by adjusting the AC voltage 80 (V_{E} in FIG. 16) to increase (decrease) the machine power injection into the dc system and, thereby, decrease (increase) the machine speed. This will move the machine speed 102 toward (away) from the maximum power point 92 (shown in FIG. 10) of the wind turbine to increase (decrease) aerodynamic efficiency depending on whether additional or less electrical power is required. In this way the power produced by the high-voltage electrostatic generator system 14 may be moderated to coordinate power generation between multiple machines and better match grid demand as communicated through voltage droop. This approach is available for a variety of different types of turbines including, for example, steam or hydro-turbines.

Referring to FIG. 16, it will be appreciated that during a low-impedance fault on the DC system, the DC voltage on the grid drops to zero at the fault location. This control curve, one sensing that loss of DC voltage, will produce a concomitant drop in excitation voltage V_{E} in a protection region 104 lower than operating region 106. In this way, the DC voltage at the output of a high-voltage electrostatic generator system 14 will also drop to a low value. implementing a form of self protection. This autonomously deenergizes the electrostatic generator system 14 in the case of a fault without requiring protection systems and switch gear.

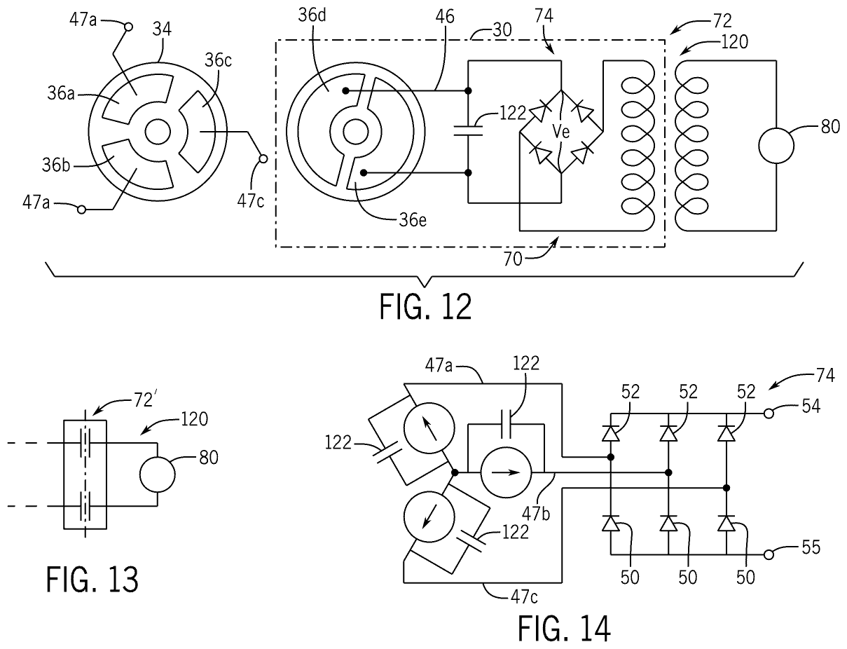

Referring now to FIG. 12, in an alternative embodiment, the stator 34 may provide individual connections to different plates 36a, 36b, and 36c at terminals 47, per the configuration of FIG. 7, and the rotor 30 may provide, for example, two electrically distinct plates 36d and 36e, for example, each subtending approximately 180° of rotor angle. These patterns may be repeated with greater spatial frequency as distinct sets or pairs, i.e., constituting “poles” in the common machine terminology. The rotor plates 36d and 36e may be connected to the excitation voltage 46 so as to apply a voltage across these rotor plates 36d and 36e and to induce a voltage in the plates 36a, 36b, 36c in sequence as the rotor 30 rotates causing a current flow into or out of the terminals associated with those plates 36a, 36b, and 36c.

The excitation voltage 46 may be communicated to the rotating rotor 30 through a rotating coupling 120, for example, being an inductive coupler formed by the isolating transformer 72 described above for the purpose of creating the floating power of the excitation voltage 46. In this coupler, a primary of the transformer 72 may be stationary and the secondary attached to rotate with the rotor 30. The rotor then includes an onboard rectifier system 74 and capacitor 122 for providing a DC voltage across the plates 36d and 36e.

The arrangement of the plates 36 will be such as to create current flow out of and into each of the plates 36a, 36b, and 36c in a different phase, for example, separated by 120° for a three-phase system.

Referring to FIG. 13, it will be appreciated that a floating voltage source may also be produced through the use of isolating capacitors 72′ both in this and the previous examples in place of the isolating transformer 72 and that these isolating capacitors 72′ may also provide a brushless rotating connector comparable to transformer 72.

Referring now to FIG. 14, terminals 47a, 47b, and 47c each connect between respective pairs of diodes 50 and 52 of a rectifier assembly 74. The pairs of diodes 50 and 52 associated with each of the terminals 47a, 47b, 47c are then connected in parallel across the terminals 54 and a common connection, and the resulting electrostatic generator 60 assembled into a high-voltage electrostatic generator system 14 by connecting the terminals 54 and 55 as shown in FIG. 6. Again, the multiple phases produced at the terminals 47a, 47b, and 47c provide for less ripple in the generated direct current and this approach can be readily expanded to phases beyond the three phases herein described.

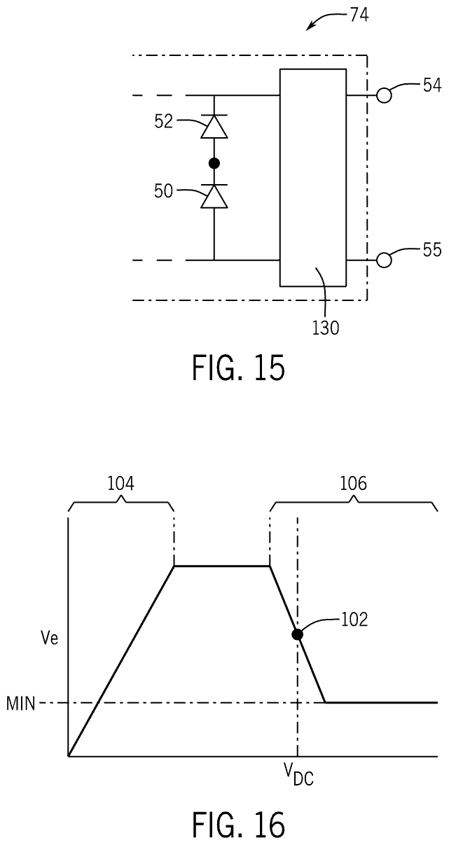

Referring now to FIG. 15, it will be appreciated that the rectifier assembly may provide for active rectification or may include a DC to DC converter such as a boost or buck converter to correct the power factor or adjust the output voltage provided by its serial connection.

Electrical isolation means that there is no path allowing indefinite unidirectional current flow between the isolated input and isolated output in a significant amount. In some examples, no unidirectional indefinite current flow will be supportable having a power of, for example, greater than 25% of the total power flow or greater than 10% of the total power flow, and typically no greater than 1% of the total power flow. Electrically isolated power sources, prior to connection to their loads, can operate at different relative voltages without current flow between them. Typically electrical isolation is obtained by converting electrical power to another form, for example, electrostatic, electromagnetic, optical power or the like.

While the present description provides a specific example using wind turbines and rotational energy sources, it will be appreciated that this invention is applicable to a wide variety of different generator types providing not only rotary mechanical motion but reciprocating or linear mechanical motion.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A high-voltage electrostatic generator system comprising:
an input shaft adapted to move under an applied mechanical force; and
a set of electrostatic generators communicating with the input shaft and each providing:
(a) a set of rotor plates communicating with the input shaft to move with motion of the input shaft;
(b) a set of corresponding stator plates capacitively coupled to the rotor plates to provide at least one varying capacitor between corresponding stator plates and rotor plates with movement of the rotor plates with respect to the stator plates;
(c) a floating voltage source connected to electrically charge the at least one varying capacitor with each floating voltage source providing a voltage prior to movement of the rotor plates with respect to the stator plates; and
(d) a rectifier assembly operating to steer current along a single charging direction, where that current results from the movement of the rotor plates with respect to the stator plates;
wherein the rectifier assemblies of the set of electrostatic generators are connected in series.

2. The high-voltage electrostatic generator system of claim 1 wherein the electrical power of the floating voltage sources is inductively or capacitively isolated from the varying capacitors.

3. The high-voltage electrostatic generator system of claim 1 wherein each rectifier assembly includes a shunting capacitor.

4. The high-voltage electrostatic generator system of claim 1 wherein each rectifier assembly conducts the same average current.

5. The high-voltage electrostatic generator system of claim 1 wherein each rotor plate and stator plate provides multiple variable capacitors having different phases of capacitance with respect to motion of the input shaft and wherein the rectifier assembly provides a separate rectifier circuit for each of the multiple variable capacitors operating to steer current from a change in the multiple variable capacitors along a common charging direction.

6. The high-voltage electrostatic generator system of claim 1 wherein the rectifier assembly steers current in either of two directions from the varying capacitor to the single charging direction.

7. The high-voltage electrostatic generator system of claim 1 wherein the floating voltage sources have a voltage in excess of 1000 V.

8. The high-voltage electrostatic generator system of claim 1 further including an output voltage monitor monitoring a voltage across the series connected electrostatic generators and controlling voltages of the floating voltage sources according to that monitoring.

9. The high-voltage electrostatic generator system of claim 8 wherein the output voltage monitor increases the excitation voltage as the monitored voltage rises within a protection region and decreases the excitation voltage as the monitored voltage increases in an operating region.

10. The high-voltage electrostatic generator system of claim 1 wherein a subset of first and second sets of rotor plates of a given electrostatic generator electrically communicate through a conduction path moving with the input shaft and wherein the floating voltage sources for each electrostatic generator are connected across stator plates associated with different of the first and second sets of rotor plates.

11. The high-voltage electrostatic generator system of claim 1 wherein the rotor plates of different pairs of subsets of first and second sets of rotor plates are at different voltages.

12. The high-voltage electrostatic generator system of claim 1 where in the rectifier assembly includes a DC to DC converter.

13. The high-voltage electrostatic generator system of claim 12 wherein the DCDC to DC converter is selected from the group consisting of a buck converter, a boost converter, and a boost-buck converter.

14. A method of transmitting electrical power employing a high-voltage electrostatic generator system having:
an input shaft adapted to move under an applied mechanical force; and
a set of electrostatic generators communicating with the input shaft and each providing:
(a) a set of rotor plates communicating with the input shaft to move with motion of the input shaft;
(b) a set of corresponding stator plates capacitively coupled to the rotor plates to provide at least one varying capacitor between corresponding stator plates and rotor plates with movement of the rotor plates with respect to the stator plates;
(c) a floating voltage source connected to electrically charge the at least one varying capacitor with each floating voltage source providing a voltage prior to movement of the rotor plates with respect to the stator plates; and
(d) a rectifier assembly operating to steer current along a single charging direction, where that current results from the movement of the rotor plates with respect to the stator plates;
wherein the rectifier assemblies of the set of electrostatic generators are connected in series; the method comprising:
(a) applying a source of mechanical power to the input shaft;
(b) extracting electrical current from a series connection of the rectifier assemblies of multiple electrostatic generators;
(c) applying the electrical current to high-voltage transmission lines for remote transmission of at least 20 km; and
(d) reducing the voltage of the electrical current and converting the electrical current to alternating current for use by consumers.

15. The method of claim 14 wherein outputs of the floating voltage sources provide a source of voltage when disconnected from the varying capacitors of high-voltage electrostatic generator system.

16. The method of claim 14 wherein outputs of the floating voltage sources excluding connection to the rotor plates and stator plates are free from ohmic interconnections with other floating voltage sources.

17. The method of claim 14 wherein the floating voltage sources have a voltage in excess of 1000 V.

18. The method of claim 14 wherein each rotor plate and stator plate provides multiple variable capacitor having different phases of capacitance with respect to motion of the input shaft and wherein the rectifier assembly provides a separate rectifier circuit for each of the multiple variable capacitors operating to steer current from a change in the multiple variable capacitors along a common charging direction.

19. The method of claim 14 further including monitoring a voltage across the series connected electrostatic generators and controlling voltages of the floating voltage sources according to that monitoring.

20. The method of claim 14 wherein the source of mechanical power is selected from the group consisting of a wind turbine, a water turbine, and a steam turbine.
